(19) United States
(12) Patent Application Publication
(10) Pub. No.: US 2011/0032199 A1
(43) Pub. Date: Feb. 10, 2011

(54) METHOD AND APPARATUS FOR CONTROLLING TOUCH SENSITIVITY IN A PORTABLE TERMINAL

(75) Inventors: Jun-Ki SEO, Gyeonggi-do (KR); Il-Seob BAEK, Gyeonggi-do (KR); Cheol-Woong PARK, Gyeonggi-do (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/849,376

(22) Filed: Aug. 3, 2010

(30) Foreign Application Priority Data
Aug. 10, 2009 (KR) 10-2009-0073127

(51) Int. Cl. G06F 3/041

(52) U.S. Cl. 345/173

(57) ABSTRACT

A method and apparatus for controlling touch sensitivity in a portable terminal are provided. The method includes controlling the touch sensitivity of a Touch Screen Panel (TSP) according to application or function in operation, and sensing a touch operation generated in the TSP at the controlled touch sensitivity.

### CLAIM OF PRIORITY

The present application claims the benefit under 35 U.S.C. §119(a) to a Korean Patent Application filed in the Korean Intellectual Property Office on Aug. 10, 2009 and assigned Serial No. 10-2009-0073127, the entire disclosure of which is hereby incorporated by reference.

### BACKGROUND OF THE INVENTION

1. Field of the Invention

The present invention relates to the field of portable terminals more particularly to a method and apparatus controlling the touch sensitivity of a Touch Screen Panel (TSP).

2. Description of the Related Art

Portable terminals are supporting various functions useful for everyday life. Such functions include a digital camera, a music player, a moving picture player, a game, a digital broadcast reception, etc. beyond simply supporting a function of a telephone call. Accordingly, the portable terminals are being recognized as necessities of modern people, and a demand for the portable terminals is being gradually diversified as well.

In compliance with the demand, recently, portable terminals supporting a touch screen function have been placed on the market. The touch screen function refers to a means for performing various operations corresponding to user's touch operations by sensing an operation of a user's touching a screen through a TSP.

Presently, released portable terminals fix the touch sensitivity of TSPs. For example, in case that the portable terminal performs a function of menu selection, character writing, drawing and camera operations, and the like, the portable terminal senses a user's touch at the same touch sensitivity for all the functions. However, in case that the portable terminal uses the same user's touch sensitivity for the functions, there is a problem that the portable terminal cannot smoothly sense a user's touch in a corresponding function, thus inducing an erroneous operation.

FIG. 1 is a diagram illustrating a touch recognition screen of a portable terminal according to the conventional art. Referring to FIG. 1, in case that the portable terminal sets a touch sensitivity of a TSP low, the portable terminal may normally recognize a menu selected by a user on a main screen in the menu selection function but, because the portable terminal cannot sense up to a user's minute touch operation in the character writing or drawing function, there is a problem that, although a user performs a curved touch, a broken or discontinued line may be input. On the contrary, in case that the portable terminal sets the touch sensitivity of the TSP high, the portable terminal normally recognizes a character input by the user in the character writing or drawing function but, there is a problem that, when the user selects a specific menu, the portable terminal may erroneously recognize that the same menu in the menu selection function was selected twice.

That is, because the conventional portable terminal fixes the touch sensitivity of the TSP and applies the fixed sensitivity to all functions irrespective of the kinds of operations, there is a problem that the portable terminal fails to smoothly perform an operation according to a user's touch, thus inducing user's dissatisfaction.

### SUMMARY OF THE INVENTION

An aspect of the present invention is to substantially solve at least the above problems and/or disadvantages and to provide at least the advantages below.

Accordingly, an aspect of the present invention is to provide a method and apparatus for controlling sensitivity of touch in a portable terminal.

Another aspect of the present invention is to provide a method and apparatus for automatically or manually controlling the touch sensitivity of a Touch Screen Panel (TSP) in a portable terminal.

A further aspect of the present invention is to provide a method and apparatus for controlling the touch sensitivity of a TSP according to software in work in a portable terminal.

The above aspects are achieved by providing a method and apparatus for controlling touch sensitivity in a portable terminal.

According to one aspect of the present invention, a method for controlling touch sensitivity in a portable terminal is provided. The method includes controlling the touch sensitivity of a TSP according to software in operation and/or values set by the user, and sensing a touch operation generated in the TSP at the controlled touch sensitivity.

According to another aspect of the present invention, an apparatus for controlling touch sensitivity in a portable terminal is provided. The apparatus includes a TSP and a TSP control unit. The TSP senses a touch operation generated by a user at a preset touch sensitivity. The TSP control unit controls the touch sensitivity of the TSP according to software in operation.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above features and advantages of the present invention will become more apparent from the following detailed description when taken in conjunction with the accompanying drawings in which:

FIG. 1 is a diagram illustrating a touch recognition screen of a portable terminal according to the conventional art;

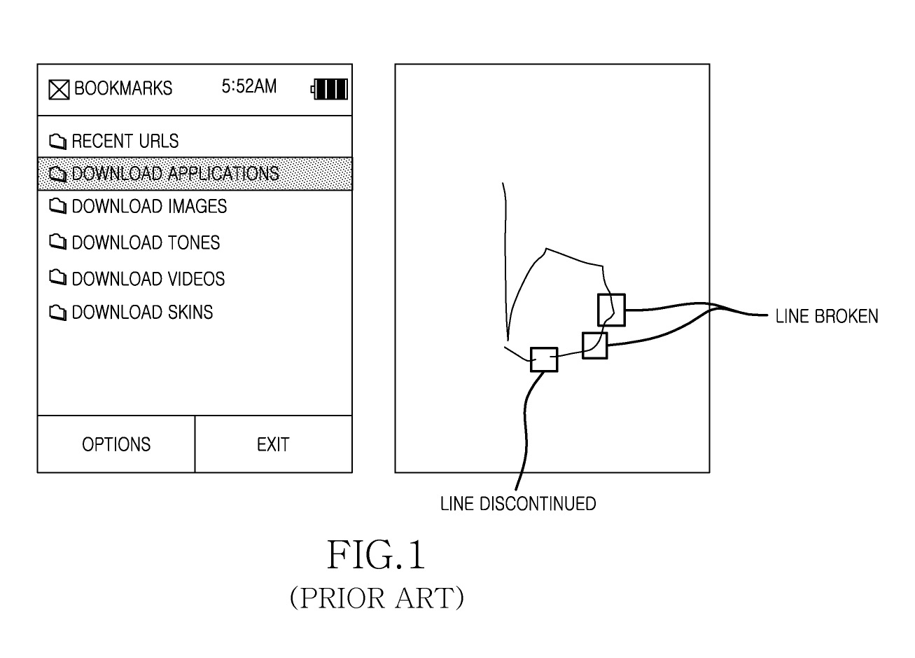

FIG. 2 is a block diagram illustrating a construction of a portable terminal according to the present invention;

FIG. 3 is a flow diagram illustrating a procedure of controlling touch sensitivity in a portable terminal according to an exemplary embodiment of the present invention; and

FIG. 4 is a diagram illustrating a screen of manually controlling touch sensitivity in a portable terminal according to an exemplary embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

The following description is made for a method and apparatus for automatically or manually controlling the touch sensitivity of a Touch Screen Panel (TSP) in a portable terminal according to an exemplary embodiment of the present invention.

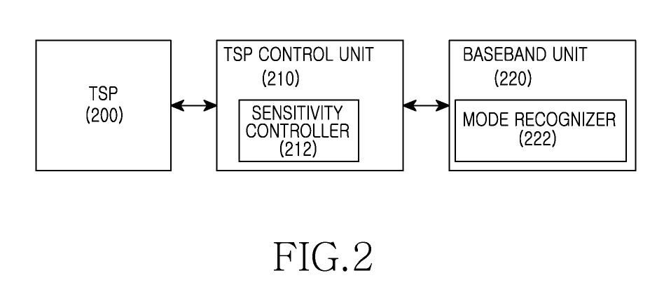

FIG. 2 is a block diagram illustrating a construction of a portable terminal according to the present invention.

Referring to FIG. 2, the portable terminal includes a TSP 200, a TSP control unit 210, and a baseband unit 220. The TSP control unit 210 includes a sensitivity controller 212, and the baseband unit 220 includes a mode recognizer 222.

The TSP 200 senses a pressure or capacitance by a user, converts the pressure or capacitance into TSP data, and outputs the TSP data. Here, the TSP data includes coordinate data on a region touched by a user. At this time, the TSP 200 senses the pressure or capacitance by the user at touch sensitivity set by the TSP control unit 210.

The TSP control unit 210 computes TSP data input from the TSP 200 according to a preset scheme, converts the computed data into a digital signal, and outputs the digital signal to the baseband unit 220. Particularly, the TSP control unit 210 includes the sensitivity controller 212 and thus, controls the touch sensitivity of the TSP 200 depending on a mode signal provided from the baseband unit 220. In detail, the sensitivity controller 212 receives a mode signal representing software presently being in operation in the portable terminal from the baseband unit 220, searches touch sensitivity corresponding to the mode signal with reference to a previously stored touch sensitivity table as shown in Table 1 (i.e., data base) below, and controls the TSP 200 to sense a user's touch operation at the searched touch sensitivity.

Table 1 below shows a touch sensitivity table, for example.

TABLE 1

| Mode | Touch sensitivity |
|---|---|
| Menu mode | Normal |
| Character mode | Normal |
| Drawing mode | Sensitive |

As shown in Table 1, if a signal representing a menu mode or character mode is input from the baseband unit 220, the sensitivity controller 212 may set the touch sensitivity of the TSP 200 to ‘normal’. If a signal representing a drawing mode is input from the baseband unit 220, the sensitivity controller 212 may set the touch sensitivity of the TSP 200 to ‘sensitive’. At this time, the touch sensitivity may be either expressed by a numerical value or may be expressed by a step. Here, the touch sensitivity table is configured with only three modes, for example. However, the touch sensitivity table may set respective modes according to various software operating in the portable terminal to set touch sensitivities corresponding to a plurality of respective modes. At this time, the touch sensitivities of the respective modes may be acquired through experiment during the years of development or by the user. In one aspect of the invention, the sensitivity level may be a function of the normal level. For example, different sensitivity levels may be determined as Sensitivity 1, 75% Normal, Sensitivity 2, 50% Normal, Sensitivity 3, 25% Normal, Sensitivity 4, 12.5% Normal, etc.

In case that it is before a mode signal is input from the baseband unit 220 or in case that a signal representing the end of a current mode is input from the baseband unit 220, the sensitivity controller 212 controls the TSP 200 to sense a user's touch operation at a basic touch sensitivity (Normal). Here, the basic touch sensitivity may be changed and set by a user.

The baseband unit 220 performs a control process for a general operation of the portable terminal. Particularly, the baseband unit 220 includes the mode recognizer 222 according to the present invention and thus, identifies software currently operating in the portable terminal and provides a signal representing a corresponding mode to the sensitivity controller 212 of the TSP control unit 210. At this time, whenever a mode corresponding to the operating software is changed, the mode recognizer 222 of the baseband unit 220 provides a signal representing the changed mode to the sensitivity controller 212. Also, when the application or function in operation is ended, the mode recognizer 222 may provide a signal representing the end of the current mode to the sensitivity controller 212.

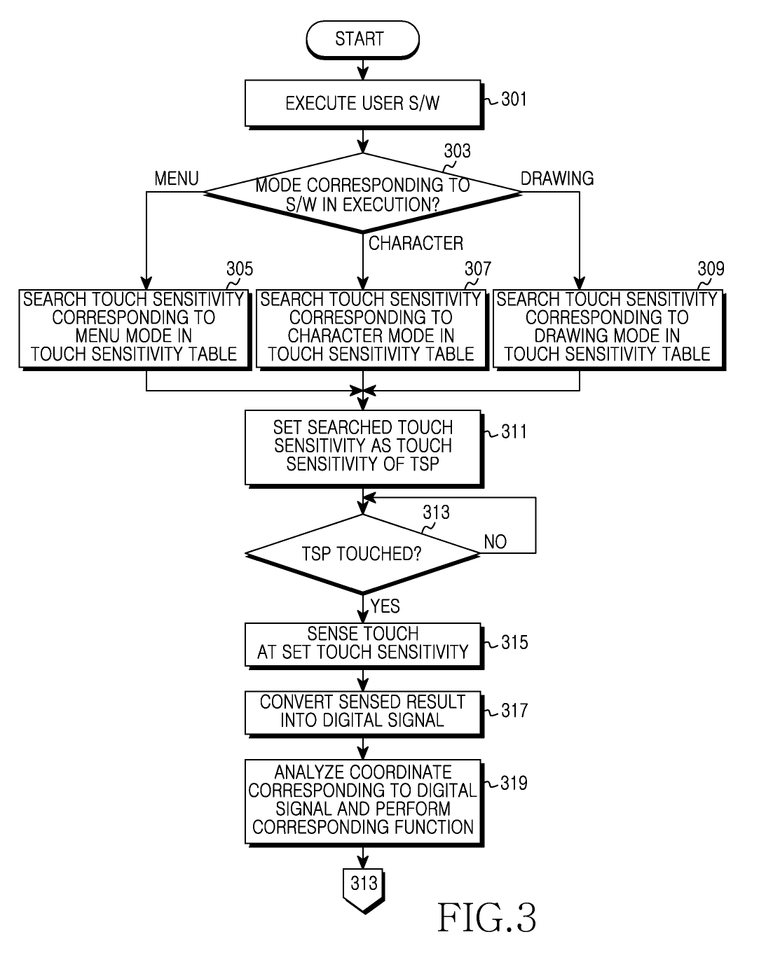

FIG. 3 illustrates a procedure for controlling touch sensitivity in a portable terminal according to an exemplary embodiment of the present invention. Here, three modes such as a menu mode, a character mode, and a drawing mode are shown in Table 1 and are described, for example. The three modes may be variously configured according to the application or function operating in the portable terminal.

Referring to FIG. 3, if the application or function (i.e., software (S/W)) is executed by a user in step 301, the portable terminal proceeds to step 303 and determines a mode corresponding to the application or function (software) in execution. For example, if a “character send” application or function (software) is executed by the user, the portable terminal identifies that a mode corresponding to the “character send” application or function (software) is the character mode.

If the mode corresponding to the application or function in execution is the menu mode, the portable terminal proceeds to step 305 and searches touch sensitivity corresponding to the menu mode in a previously stored touch sensitivity table, and proceeds to step 311 below. For example, the portable terminal identifies that sensitivity corresponding to the menu mode as ‘normal’ from the touch sensitivity table of Table 1.

If the mode corresponding to the application or function in execution is the character mode, the portable terminal proceeds to step 307 and searches touch sensitivity corresponding to the character mode in the previously stored touch sensitivity table, and proceeds to step 311 below. For example, the portable terminal identifies that sensitivity corresponding to the character mode as ‘normal’ from the touch sensitivity table of Table 1.

If the mode corresponding to the application or function in execution is the drawing mode, the portable terminal proceeds to step 309 and searches touch sensitivity corresponding to the drawing mode in the previously stored touch sensitivity table, and proceeds to step 311 below. For example, the portable terminal identifies that sensitivity corresponding to the drawing mode as ‘sensitive’ from the touch sensitivity table of Table 1. As would be recognized, the “sensitive” setting may be one of a plurality of sensitivity levels that may be independently set or may be a one or more functions of a normal setting.

After that, in step 311, the portable terminal sets the searched touch sensitivity as the touch sensitivity of a TSP. Then, the portable terminal proceeds to step 313 and senses if the TSP is touched.

If the TSP is touched the portable terminal senses a user's touch operation at the set touch sensitivity, in step 315. Then, the portable terminal proceeds to step 317 and converts the sensed result into a digital signal. Then, in step 319, the portable terminal analyzes a coordinate corresponding to the digital signal and performs a corresponding function. After that, the portable terminal returns to step 313.

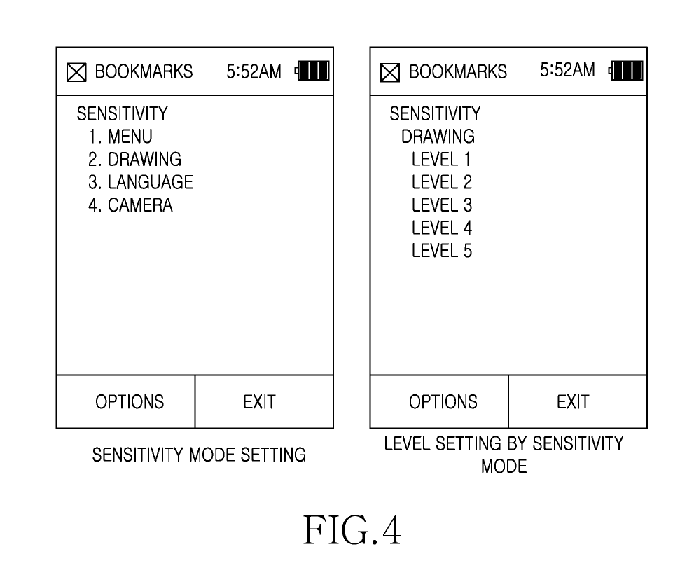

The above description is made for automatically controlling touch sensitivity according to a mode of software operating in a portable terminal. In addition to this, a user may also manually control touch sensitivity irrespective of application or function operating in the portable terminal. That is, the present invention may allow the user to set his/her desiring touch sensitivity, by providing a user interface capable of controlling touch sensitivity by each mode of application or function provided in the portable terminal. For example, the present invention may provide a user interface capable of setting touch sensitivity levels to use in ‘Menu’, ‘Drawing’, ‘Language’, and ‘Camera’ modes as illustrated in FIG. 4. For example, different levels (Level 1, . . . Level 5) of sensitivity may be selected for the drawings. Similarly, different levels of sensitivity may be selected for other operations such a menu, language and camera, etc.

As described above, by automatically controlling the touch sensitivity of a TSP according to software in operation in a portable terminal, the present invention has an effect of reducing the probability of an erroneous operation of the portable terminal resulting from erroneously recognizing a user's touch. By allowing a user to personally control touch sensitivity suitably to his/her personality, the present invention has an effect of solving a user's dissatisfaction.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method, operable in a processor, for controlling touch sensitivity in a portable terminal, the method comprising:
controlling the touch sensitivity of a Touch Screen Panel (TSP) according to an application or function in operation in the processor; and
sensing a touch operation generated in the TSP at the controlled touch sensitivity.

2. The method of claim 1, wherein controlling the touch sensitivity according to the application or function in operation comprises:
determining touch sensitivity corresponding to the application or function in operation; and
controlling the touch sensitivity of the TSP to the determined touch sensitivity.

3. The method of claim 1, wherein the touch sensitivity is previously determined as a function of a normal sensitivity, or is determined by a user.

4. An apparatus for controlling touch sensitivity in a portable terminal, the apparatus comprising:
a touch screen panel (TSP) for sensing a touch operation generated by a user at a preset touch sensitivity; and
a TSP control unit for controlling the touch sensitivity of the TSP according to application or function in operation.

5. The apparatus of claim 4, further comprising a baseband unit for informing the TSP control unit of the application or function in operation in the portable terminal.

6. The apparatus of claim 4, wherein the touch sensitivity is previously set or is set by a user.

7. The apparatus of claim 6, wherein the previously set touch sensitivity is determined as a function of a Normal sensitivity.

8. A portable terminal comprising:
a touchscreen; and
a processor in communication with a memory, the memory including code, which when accessed by the processor causes the processor to:
receive an input from the touchscreen;
determine an application executing in the processor;
determine an intensity of the received input;
compare the determined intensity with a sensitivity associated with the determined application executing in the processor; and
accept the input when the determined intensity is comparable to the sensitivity associated with the determined application executing in the processor.

9. The portable terminal of claim 8, further comprising:
a data base including sensitivity levels as a function of applications.

10. The portable terminal of claim 9, wherein the sensitivity levels in the data base on determined based on a function of a normal sensitivity.

11. The portable terminal of claim 9, wherein the sensitivity levels in the data base are manually determined.

12. The portable terminal of claim 8, further comprising:
a mode recognizer for recognizing an application executing in the processor.

13. The portable terminal of claim 12, further comprising:
a sensitivity controller, receiving an input from the mode recognizer, to determine a sensitivity level.
